(19) United States
(12) Patent Application Publication
(10) Pub. No.: US 2014/0105240 A1
(43) Pub. Date: Apr. 17, 2014

(54) Slag Freeze-Lining for Electronic Arc Furnace

(71) Applicant: Brian Bowman, Westlake, OH (US)

(72) Inventor: Brian Bowman, Westlake, OH (US)

(73) Assignee: GRAFTECH INTERNATIONAL HOLDINGS INC., Parma, OH (US)

(21) Appl. No.: 14/125,620

(22) PCT Filed: Jun. 22, 2012
(86) PCT No.: PCT/US12/43721

§ 371 Date: Dec. 12, 2013

Related U.S. Application Data
(60) Provisional application No. 61/501,006, filed on Jun. 24, 2011.

(51) Int. Cl. F27D 1/16; F27D 11/08

(52) U.S. Cl. CPC F27D 1/1684; F27D 11/08
USPC 373/76

(57) ABSTRACT

An improved method of operating an arc furnace is provided. The sidewall of the furnace includes a refractory lining. A charge of scrap metal is added to the furnace. The charge is melted and a slag layer is formed on the top of the melting charge. The furnace is tapped at the bottom to remove a portion of the melted charge. After tapping the furnace, the slag is splashed onto the sidewall to thereby coat the sidewall with a frozen slag layer.

### BACKGROUND

Modern alternating current electric arc furnaces generally include three sections: a lower bowl shaped section, a cylindrical sidewall, and a roof. The lower bowl section is made from refractory bricks while the sidewalls and roof are made from water cooled panels. These water cooled panels are formed by steel or copper tubing arranged in a repeating serpentine pattern. The panels may further include a steal or copper backing plate. Pressurized water is pumped through the tubing to prevent the sidewalls and roof from overheating and degrading or melting when exposed to the intense heat generated in the arc furnace.

Alternating current (AC) furnaces have three electrodes which are connected through a transformer to a high voltage source. Alternatively the furnace may be powered in direct current (DC), usually through one electrode. An arc forms between the charged material (typically steel scrap) and the electrode(s). The charge is melted down by the power generated in the arc(s).

An important part of steelmaking is the formation of slag, which floats on the surface of the molten steel. Slag is made of a variety of elements, including for example metal oxides, and functions, among other things, to absorb oxidised impurities. Slag formers may be calcium oxide (burnt lime) and/or magnesium oxide (dolomite and magnesite). These materials may be charged with the scrap, or added into the furnace at a later point after the charge is partially melted. Another major component of the slag may be iron oxide from steel combusting with oxygen in the furnace. Later in the heat, carbon (in the form of coke or coal) is injected into this slag layer, reacting with the iron oxide to form metallic iron and carbon monoxide gas, which then causes the slag to foam, allowing greater thermal efficiency, and better arc stability and electrical efficiency.

An arc furnace is generally an oxidizing steelmaking unit, so normally one would not consider graphite or carbon based refractories to have a successful application as a refractory material. Up to the mid '70s dolomite- or magnesite-based refractories were standard lining materials for arc furnace side walls and/or roofs. As furnaces (AC) became more powerful in the 60s and 70s three hot spots were observed at the side wall and roof areas closes to each electrode. Refractory erosion in the three ‘hot spots’ became a serious technical limitation, often requiring the walls of the furnace to be completely replaced every 2 to 4 weeks. The solution to this problem arose in the 70s with the aforementioned water-cooled panels. This new technology spread rapidly, relieving the steelmaker of the necessity to run with short arcs and allowing longer arcs at lower currents. Today, refractories are only used in the arc furnace in areas that handle liquid steel directly (i.e. the lower bowl shaped section).

### SUMMARY OF THE EMBODIMENTS

According to one aspect of the present disclosure, a method of operating an AC or DC arc furnace is provided. The sidewall of the furnace includes a refractory lining A charge of scrap metal is added to the furnace. The charge is melted and a slag layer is formed on the top of the melting charge. The furnace is tapped at the bottom to remove a portion of the melted charge. After tapping the liquid steel from the furnace, slag remaining in the furnace is modified by additions when necessary and then splashed onto the sidewall to thereby coat it with a slag layer which acts as a protective coating for the following heat.

### BRIEF DESCRIPTION OF THE DRAWINGS

FIG. 1 is a side view of an arc furnace.

FIG. 2 is an enlarged view of a side-wall having a slag coating.

### DETAILED DESCRIPTION OF THE INVENTION

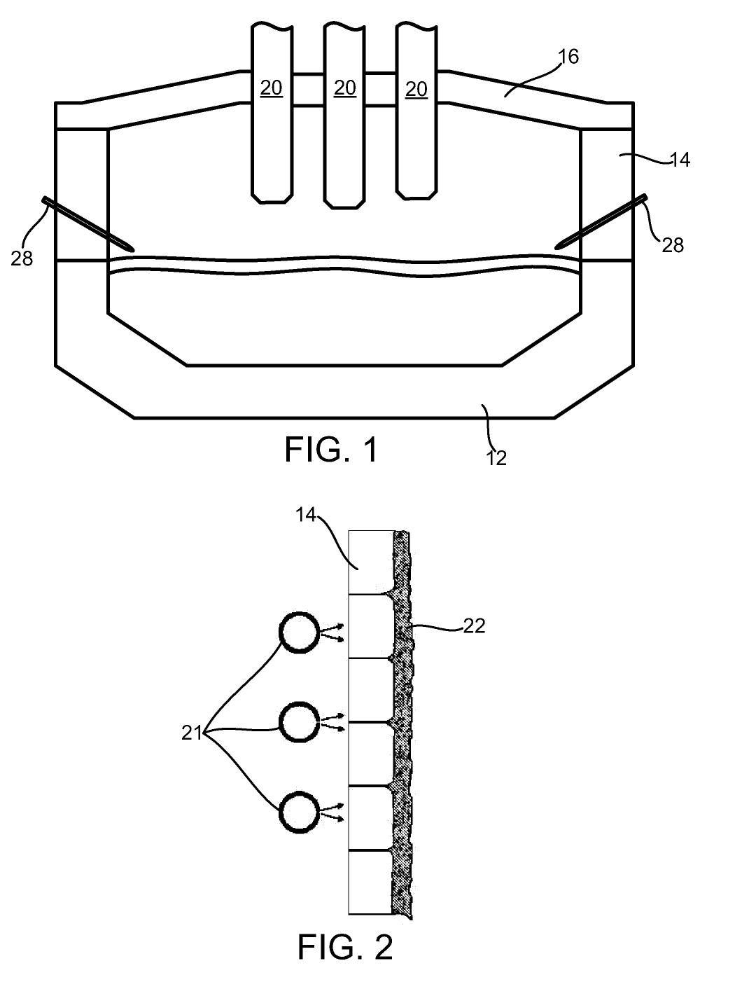

With reference now to FIG. 1, as an example, an alternating current arc furnace is shown and generally indicated by the numeral 10. Furnace 10 includes a containment vessel having three sections: a lower bowl shaped section 12, sidewalls 14, and a roof 16. The roof 16 is movable to provide access to the interior of the containment vessel and allow the addition of a charge of scrap material 18 which is to be melted/refined. Three electrodes 20 extend through apertures in the roof 16 and the lower bowl shaped section 12 is made from a refractory material. Likewise, the sidewalls 14 and roof 16 may be made from refractory material. It should be appreciated that, thought the present embodiment includes all major portions of the containment vessel being substantially formed from refractory material, it should be appreciated that, just one of the side wall 14 or roof 16 may be made from refractory material. Further, only a portion of the side wall 14 or roof 16 may be made from refractory brick. In one embodiment at least 50 percent of the interior facing surface area of the roof 16 is made from refractory material. In another embodiment, at least 75 percent of the interior facing surface area of the roof 16 is made from refractory material. In a further embodiment, at least 90 percent of the interior facing surface area of the roof 16 is made from refractory material. In this or other embodiments, at least 50 percent of the interior facing surface area of the side wall 14 is made from refractory material. In further embodiments, at least 75 percent of the interior facing surface area of the side wall 14 is made from refractory material. In still further embodiments, at least 90 percent of the interior facing surface area of the side wall 14 is made from refractory material. In one embodiment, the refractory side wall or roof is from between about 15 cm and about 40 cm thick. In other embodiments the refractory is from between about 10 cm and about 30 cm.

With reference now to FIG. 2, a cooling system 21 may be provided proximate to the exterior surface of side wall 14 and/or roof 16. Cooling system 21 may, for example, be in the form of misters that provide a continuous stream of water to contact the exterior surface of side wall 14 and/or roof 16. It should be appreciated, however, that other cooling systems 21 may be provided. For example, a forced air system could blow cooling air over the exterior surface of the side wall 14 and/or roof 16. The cooling systems described and contemplated hereinabove would draw some thermal energy out of the furnace, thus reducing the furnace power efficiency. In one embodiment, at least one of the side wall or the roof causes less than about 30 kW/m² of energy loss averaged over a typical heat. In other embodiments, the at least one of the roof or the side wall causes less than about 25 kW/m² of energy loss averaged over a typical heat. In still further embodiments, the energy loss of at least one of the roof or sidewall is from between about 12 and about 23 kW/m² averaged over a typical heat. Though these losses are not insignificant, they are far less than the prior art wall and roof water-cooled copper panels which can together absorb from about 40 to about 60 kW/m².

The refractory material may advantageously be in the form of bricks. In one embodiment bricks are generally rectangular having a volume greater than about 5,900 cm³. In other embodiments, the brick has a volume greater than about 8,900 cm³. In still other embodiments, the brick has a volume greater than about 11,900 cm³. In one embodiment, the height of the brick may between about 7.5 and about 15.0 cm. In one embodiment, the width of the brick may be between about 17.5 cm and about 27.5 cm. The one embodiment, the length of the brick may be from between about 20 cm to about 50 cm.

In one embodiment, the refractory bricks may be made substantially of carbon. The carbon brick may be made, for example, by combining pitch with a high carbon content material such as coke and one or more additional additives. The mixture may be extruded or pressed into brick form. The brick may then be advantageously baked, at greater than 800 degrees C., and more advantageously greater than about 1,000 degrees C. for sufficient time to drive out the volatiles and complete solidification of the brick. Additives may include sand, semi-graphitized coke, coal scrap, graphite powder or scrap, sulphur, silicon powder, boron carbide powder, and natural graphite. Though the carbon brick described herein above is advantageous, refractory brick made principally of other materials may be employed such as, for example, silica, silicon carbide, silicon dioxide, boron carbide, ceramic, aluminium oxide and/or alumina.

In one embodiment, the refractory brick may have a density of about 1.4 gm/cc to about 2.0 gm/cc as measured by test procedure ASTM C559. In other embodiments, the refractory brick density may be about 1.5 gm/cc to about 1.7 gm/cc. In still further embodiments, the refractory brick density may be from about 1.7 to about 1.9 gm/cc. In one embodiment the against-grain crush strength of the refractory brick may be from about 20,000 kPa to about 35,000 kPa as measured by test procedure ASTM C133. In other embodiments, the against-grain crush strength of the refractory brick may be from about 33,000 kPa to about 28,000 kPa. The refractory brick preferably has ash content less than about 20 percent, more preferably less than about 15 percent and even more preferably less than about 12 percent as measured by test procedure ASTM C561. The refractory brick may have a with-grain permeability of from between about 5 and about 30 milli-darcy as measured by test procedure ASTM C577. In one embodiment, the refractory brick may have a with-grain thermal conductivity of from between about 5 and about 120 W/m-K at 20 degrees C. using test procedure ASTM C714. In other embodiments the with-grain thermal conductivity is from between about 10 and about 60 W/m-K. In other embodiments, the refractory brick with-grain thermal conductivity of greater than about 20 W/m-K. In a further embodiment the refractory brick with-grain thermal conductivity is greater than about 50 W/m-K. In still further embodiments, the refractory brick with-grain thermal conductivity is greater than about 70 W/m-K.

A typical heat cycle includes the addition of a first charge of scrap material into the furnace. The charge is then heated by passing high voltage electricity through electrodes 20 causing electric arcs to extend to the scrap. Once the first charge is heated and substantially melted, a second charge is commonly added. It should be appreciated that, though a two charge cycle is common, some furnaces may operate with only a single charge per heat cycle. After the second charge is added (or after the first charge in a single charge heat cycle) slag foaming agents may be added to the furnace to promote slag foaming. Finally, after the scrap charge is liquefied, the furnace is tapped at the bottom to drain the molten steel. The entire contents are not drained, however, as the slag layer is not desirable in the end product. Further, the next heat is aided by maintaining the slag and some molten steel in the furnace.

Substitution of the water-cooled panels with refractories, without further steps to protect the refractories, will result in rapid oxidation of the side wall and roof refractories. Therefore, according to one embodiment, substantially all of the inner facing surface area of the refractory material of the side wall and roof is coated with a solid layer of slag 22. In this manner, oxidation can be substantially reduced. Advantageously, the slag 22 in contact with the refractory surface should be solid and not in liquid form running down the hot surface of the refractory material. In one embodiment, the slag layer is from between about 1.0 cm to about 6.0 cm. In other embodiments the slag layer is from between about 2.0 cm and about 5.0 cm. In this or other embodiments, throughout a heat the slag layer is preferably greater than 0.5 cm, even more preferably greater than 1.0 cm and still more preferably greater than about 2.0 cm.

Portions of the slag layer adhering to the refractory material may melt at the surface for some periods of the heat. This is due to the high inside temperatures of the wall or roof lining which may vary from room temperature after scrap charging to from between about 1400 C to about 1600 C just prior to tapping. Slag has a low thermal conductivity (approximately 2 W/mK) relative to refractory material. Thus, a high temperature gradient is formed in the refractory from the interior facing surface outward from between about 2 cm to about 4 cm. The portion of the slag layer that melts during a heat may advantageously be replaced by a slag splashing technique which will be described in greater detail hereinbelow. In this manner, it is ensured that the solid slag layer is never melted all the way to the refractory surface.

Slag melting temperature is dependent on slag chemistry, particularly the FeO and MgO levels. In one embodiment, the slag melting temperature is from between about 1250 C and about 1450 C. In other embodiments, the slag melting temperature is from between about 1300 C and about 1400 C. In still further embodiments the slag melting temperature is from between about 1325 C and about 1375 C.

Advantageously, the slag splashing is employed in a two step process. In a first step, the arcs themselves cause the slag to splash onto the walls and roof of the furnace. Specifically, after the walls are uncovered by scrap in early meltdown and before slag is foamed, the pressure wave caused by the arcs advantageously splash molten slag onto the interior surfaces of the walls and roof. In one embodiment, the first slag splash is performed from about 10 percent to about 40 percent of the power-on time. In other embodiments, the first slap splash is performed from about 20 to about 30 percent of the power-on time. In these or other embodiments, the power-on time may be from about 25 minutes to about 55 minutes. In other embodiments, the power-on time may be from about 35 to about 45 minutes.

As discussed above, after each heat, the liquid steel is drained from a tap hole at the bottom of the furnace. However, advantageously, a substantial portion of the slag, which floats on top of the liquid steel, remains inside the furnace. In other words, the tap is stopped prior to draining the slag. After the liquid steel is drained, and before the next charge of scrap is dropped into the furnace, the second application of slag to the side walls and/or roof may be performed. At this point in the process, the slag is no longer foaming. The second slag splashing application employs a lance 28 that directs a high pressure gas onto the slag, causing it to splash onto the side wall and/or roof refractories. Though the figures show a pair of lances 28, it should be appreciated that more or less than two lances may be employed. Further, though the figures show the lance 28 extending inwardly from the side wall 14, one or more lances may also extend inwardly from the roof 16. The lance(s) 28 advantageously blows nitrogen, but may also blow other gasses, for example, air. Prior to splashing, it may be necessary to tune the slag properties. For example, additives may be provided that increase viscosity to promote adhesion to the side walls and/or roof.

Lance 28 may be a dedicated slag splashing lance or may advantageously also perform a second function apart from slag splashing. Lance 28 may also blow oxygen into the furnace at other times during the heat, which burns to maintain the proper temperature within the furnace. In one embodiment, lance(s) 28 blow oxygen into the furnace while the slag is foaming. In this or other embodiments, the lance(s) 28 direct oxygen into the furnace from between the latter 10 percent to the later 40 percent of the heat. In other embodiments, the lance(s) 28 direct oxygen into the furnace from between the latter 20 percent to 30 percent of the heat.

In the above manner, the refractory material of the side wall and/or roof is provided with a coating of solid slag that is refreshed prior to the beginning of each heat. By providing the slag coating, oxidation of the refractory of the side wall and roof may be significantly reduced. Further, by using refractory materials instead of the prior art water cooled panels, safety is improved. Specifically, the water cooled panel relies on pressurized water being continuously pumped therethrough. If a leak occurs, in the right conditions, an explosion could result. This type of explosive sequence is avoided by using the refractory material in accordance with the above discussion.

The various embodiments described herein can be practiced in any combination thereof. The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims.

What is claimed is:

1. A method of operating a 3-phase electric arc furnace having a lower bowl, sidewall, and a roof, the method comprising:
providing a refractory lining for the sidewall;
adding a charge of scrap metal to the furnace;
melting said charge;
forming a slag layer as said charge melts;
tapping at least a portion of the melted charge; and
after said tapping step, splashing said slag onto said sidewall to thereby coat said sidewall with a frozen slag layer.

2. The method of claim 1 wherein said furnace includes at least one lance and said step of splashing said slag further comprises blowing a gas out of said lance to splash said slag.

3. The method of claim 2 wherein said gas is substantially comprised of nitrogen.

4. The method of claim 1 wherein said refractory is comprised of substantially carbon.

5. The method of claim 1 wherein said refractory is comprised of substantially ceramic.

6. The method of claim 1 wherein the thermal conductivity of said refractory is from between about 10 and about 100 W/m-K.

7. The method of claim 6 wherein the thermal conductivity of said refractory brick is greater than about 20 W/m-K.

8. The method of claim 6 wherein the thermal conductivity of said refractory brick is greater than about 50 W/m-K.

9. The method of claim 1 further comprising providing a refractory lining for said roof.

10. The method of claim 1 wherein said refractory lining causes less than about 30 kW/m² of energy loss averaged over a heat.

11. The method of claim 1 wherein said frozen slag layer is greater than about 1.0 cm.
